(19) United States
(12) Patent Application Publication
(10) Pub. No.: US 2025/0200683 A1
(43) Pub. Date: Jun. 19, 2025

(54) METHOD FOR EXTRACTING OBJECTIVE AND SOLUTION OF PATENT DOCUMENT BASED ARTIFICIAL INTELLIGENCE AND COMPUTING DEVICE

(71) Applicant: WERT INTELLIGENCE CO., LTD., Seoul (KR)

(72) Inventor: JungHo Yun, Seoul (KR)

(73) Assignee: WERT INTELLIGENCE CO., LTD., Seoul (KR)

(21) Appl. No.: 18/979,917

(22) Filed: Dec. 13, 2024

(30) Foreign Application Priority Data
Dec. 13, 2023 (KR) 10-2023-0181292
Dec. 13, 2024 (KR) 10-2024-0186556

(51) Int. Cl. G06Q 50/18; G06F 40/289; G06F 40/58

(52) U.S. Cl. CPC G06Q 50/184; G06F 40/289; G06F 40/58

(57) ABSTRACT

A method and a computing device for extracting the objective and solution of patent document based on artificial intelligence AI is disclosed. The method for extracting objectives and solutions from patent documents performed by a computing device, comprising: extracting objectives and solutions from the technical content included in a first patent document; receiving a viewing request for the first patent document; displaying the objectives and solutions of the first patent document in response to the viewing request; searching for at least one second patent document having the same or similar solution as the patent document and having different objectives, in response to a searching request for the objective form a user; and providing at least one second patent documents.

### TECHNICAL FIELD

The present invention relates to a method and a computing device for extracting the objective and solution of patent document based on artificial intelligence AI, and more specifically, to a method for extracting the objective and solution from a patent document using AI technology.

### BACKGROUND

Various patent document offices and companies around the world are seeking efficient ways to utilize the technical and legal content included in patent documents. One approach to achieving this is extracting the objectives and solutions described in patent documents.

Patent documents contain extensive technical content spanning dozens of pages, making it difficult to clearly identify which parts correspond to the objectives and solutions. Since objectives and solutions are widely used for R&D strategy development and patent document analysis, there is a growing demand for an accurate and efficient method to extract this information from a large number of patent documents.

### DISCLOSURE

### Technical Problem

According to one embodiment of the present invention, by providing the purpose and solution of a patent document, a user may quickly and easily understand the core contents of a patent document.

### Technical Solution

According to one embodiment of the present invention, a method for extracting objectives and solutions from patent documents performed by a computing device, comprising: extracting objectives and solutions from the technical content included in a first patent document; receiving a viewing request for the first patent document; displaying the objectives and solutions of the first patent document in response to the viewing request; searching for at least one second patent document having the same or similar solution as the patent document and having different objectives, in response to a searching request for the objective form a user; and providing at least one second patent documents.

According to one embodiment of the present invention, a method for extracting objectives and solutions from patent documents performed by a computing device, comprising: extracting objectives and solutions from the technical content included in a first patent document; receiving a viewing request for the first patent document; displaying the objectives and solutions of the first patent document in response to the viewing request; searching for at least one second patent document having the same or similar objective as the patent document and having different solutions, in response to a searching request for the solution form a user; and providing at least one second patent documents.

According to one embodiment of the present invention, a computing device for performing a method of extracting objectives and solutions from patent documents, computing device comprising a processor, wherein the processor is configured to: extract objectives and solutions from the technical content included in a first patent document; receive a viewing request for the first patent document; display the objectives and solutions of the first patent document in response to the viewing request; search for i at least one second patent document having the same or similar solution as the patent document and having different objectives, in response to a searching request for the objective, or ii at least one second patent document having the same or similar objective as the patent document and having different solutions, in response to a searching request for the solution, and provide at least one second patent documents.

### ADVANTAGEOUS EFFECTS

According to one embodiment of the present invention, the objectives and solutions of a user-selected patent document are presented, while also identifying global patent documents that propose the same solution but different objectives.

According to another embodiment of the present invention, the objectives and solutions of a user-selected patent document are presented, while also identifying global patent documents that propose the same objective but different solutions.

### DESCRIPTION OF DRAWINGS

FIG. 1 is a diagram illustrating a method for extracting objectives and solutions from patent documents based on AI according to an embodiment of the present invention.

FIG. 2 is a diagram illustrating the process of extracting objectives and solutions using an AI model according to an embodiment of the present invention.

FIG. 3 is a diagram illustrating the process of performing a similarity comparison between objectives and solutions of patent documents filed in different countries according to an embodiment of the present invention.

FIG. 4 is a diagram presenting the objectives and solutions of a patent document according to an embodiment of the present invention.

FIG. 5 is a diagram illustrating an example list of global patent documents having the same or similar solution and different objectives for a user-selected patent document according to an embodiment of the present invention.

FIG. 6 is a diagram illustrating an example list of global patent documents having the same or similar objective and different solutions for a user-selected patent document according to an embodiment of the present invention.

### DETAILED DESCRIPTION

The present invention to be described below may have various modifications and various embodiments, and specific embodiments will be illustrated in the drawings and described in detail. However, the present invention to be described below is not limited to specific embodiments, and it should be understood that the present invention covers all modifications, equivalents and replacements included within the technical idea and technical scope of the present invention.

Terms such as first, second, A, and B may be used for describing various components, but the components are not limited by the terms and the terms are used only for distinguishing one component from other components. For example, a first component may be referred as a second component, and similarly, the second component may also be referred as a first component, without departing from the scope of the invention to be described below. A term ‘and/or’ includes a combination of a plurality of associated disclosed items or any item of the plurality of associated disclosed items.

It is to be understood that singular expression encompass plural expressions unless otherwise indicated in the context, and it should be understood that term “including” or the like indicates that a feature, a number, a step, an operation, a component, a part or the combination thereof described herein is present, but does not exclude a possibility of presence or addition of one or more other features, numbers, steps, operations, components, parts or combinations thereof.

Before the detailed description of the drawings, the distinction to components herein is to clarify that each component is only distinguished for each main function of each component. That is, two or more components to be described below may be combined into one component or one component may be divided into two or more components for each subdivided function. In addition, each of the components to be described below may additionally perform some or all of the functions that are handled by other components in addition to main functions that the corresponding component is responsible for, and some of the main functions of which the respective components are charged may be exclusively carried out by other components.

Further, in performing methods or operating methods, respective processes of configuring the method may be performed differently from a specified order unless otherwise disclose a specific order in the context. That is, the respective processes may be performed similarly to the specified order, performed substantially simultaneously, and performed in an opposite order.

The present invention is based on a website/server or a computer program/application in which a patent document search function is implemented by the website/server providing a patent document search engine. Thus, the embodiments described herein may be performed by a web server, an application server, and/or a client device, and a system including them may be collectively referred to as a ‘patent document classification system.’ Hereinafter, for convenience of description, a subject performing the embodiment has been described with the ‘patent document search engine’ or the ‘patent document classification system,’ but may be described to be replaced with a web server, an application server, and/or a client device. Further, for convenience of description, the present invention has been described based on a patent document search engine provided through a website, but is not limited thereto, and may be applied even to a patent document search engine provided through an application.

First, a basic function and a graphic user interface GUI of the patent document search engine of the present invention will be described and then a method for automatically classifying patent documents will be described in detail.

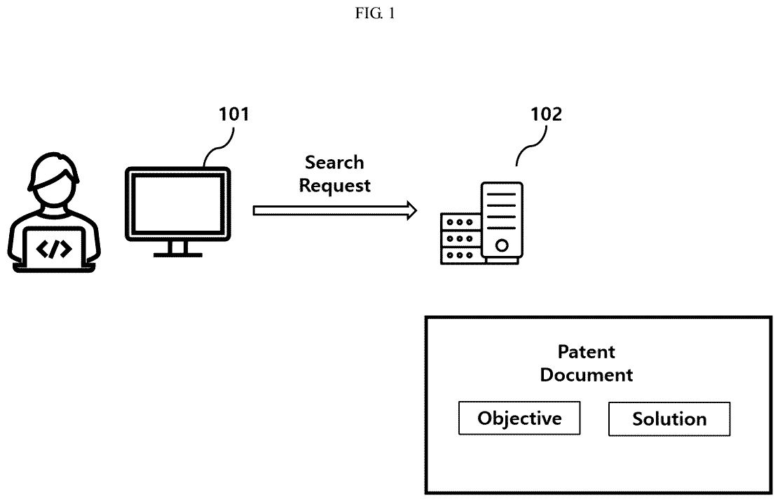

FIG. 1 is a diagram illustrating a method for extracting objectives and solutions from patent documents based on AI according to an embodiment of the present invention.

Referring to FIG. 1, user terminal 101 may request computing device 102 to provide access to a user-selected patent document. Computing device 102 may provide a service that displays information regarding the objectives and solutions of the patent document. In response to a request from the user terminal 101, computing device 102 may provide the patent document along with the objectives and solutions extracted by the AI model from the technical content included in the patent document.

The objectives and solutions of a patent document may be key information for quickly understanding the patent document and may be extracted separately from the patent document abstract. The objective of a patent document may be derived from sections such as the background technology, application field, and effects of the patent document.

Thus, training data for an AI model may be extracted from sections such as the background technology and effects across patent documents filed in different countries. Meanwhile, the solution may be extracted from the claims both independent and dependent claims and the detailed description of the invention.

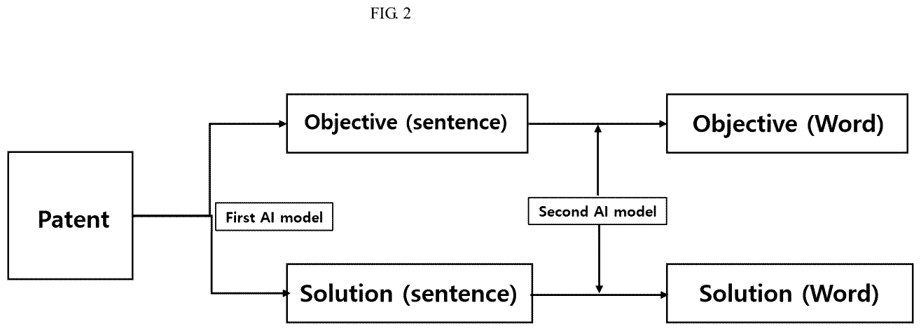

FIG. 2 is a diagram illustrating the process of extracting objectives and solutions using an AI model according to an embodiment of the present invention.

According to an embodiment of the present invention, a computing device 102 may extract an objective and a solution in sentence units from the entire specification of a patent document through a first AI model. Then, computing device 102 may summarize the objective and solution in sentence units through a second AI model and extract an objective and a solution in word units.

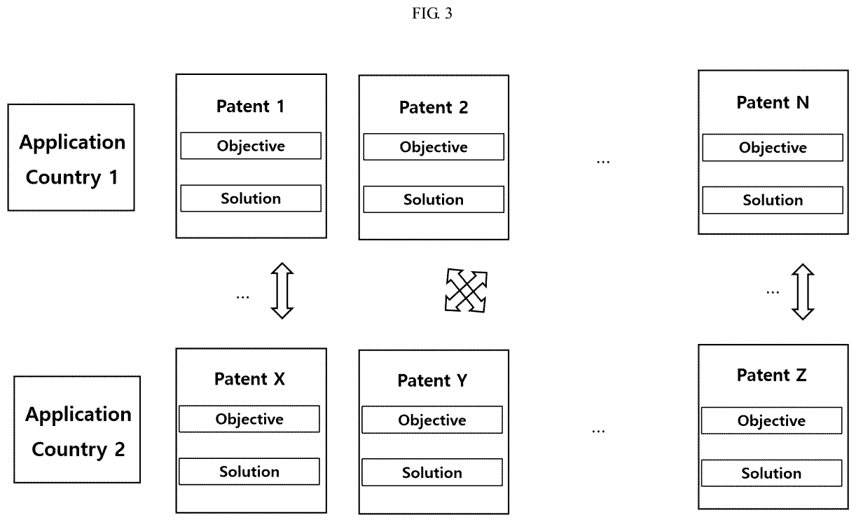

FIG. 3 is a diagram illustrating the process of performing a similarity comparison between objectives and solutions of patent documents filed in different countries according to an embodiment of the present invention.

According to an embodiment of the present invention, the objective and solution may be extracted from patent documents issued in countries around the world. At this time, they may be composed in different languages for each country. Computing device 102 may translate the objective extracted from the patent documents composed in different languages into one language, and then compare the similarity between the objectives unified in one language. In addition, the solution extracted from the patent documents composed in different languages may be translated into one language, and then the similarity may be compared between the solution unified in one language.

Here, the comparison of similarity may be determined based on the number of components composed of nouns described in the objective or solution, the positions of the components, the order of the components, and the importance of the components.

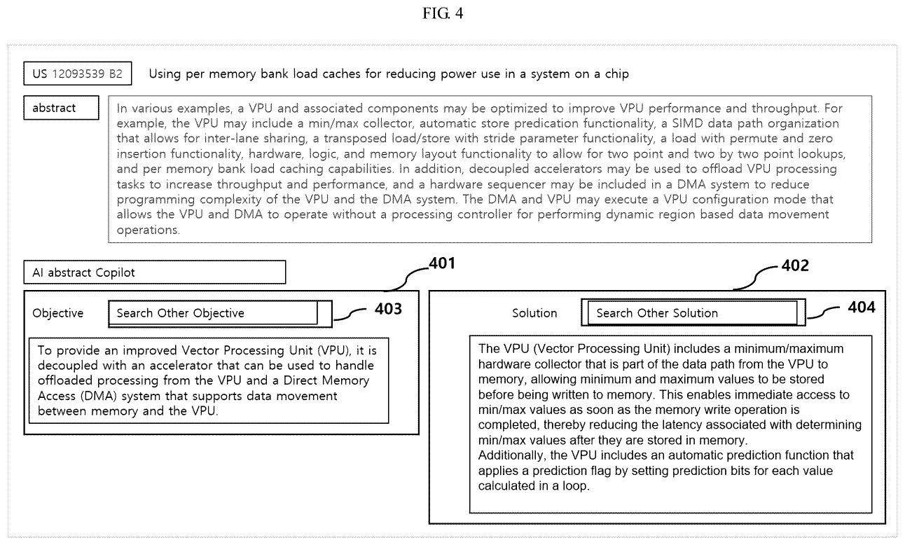

FIG. 4 is a diagram presenting the objectives and solutions of a patent document according to an embodiment of the present invention.

Referring to FIG. 4, the objective and solution of a patent document requested to be viewed by a user are provided. Computing device 102 may provide the objective 401 and solution 402 extracted through an AI model together with the content matching the index originally included in the patent document, such as a summary, a description of a drawing, and claims.

If the user selects US patent document registration U.S. Pat. No. 12,093,539B2, computing device 102 may provide the objective and solution for US patent document registration U.S. Pat. No. 12,093,539B2. At this time, computing device 102 may provide the objective and solution by translating it into a set language Korean.

Computing device 102 may extract the objective 401 and the solution 402 from patent documents around the world. Thus, computing device 102 may provide the objective 401 and the solution 402 extracted in advance or in real time for the patent document that the user has requested to view.

In addition, computing device 102 may display a menu 403 that allows the user to check patent documents from around the world that provide an objective 401 for the patent document and at the same time have a solution 402 that is the same or similar to the patent document but has a different objective. In addition, computing device 102 may display a menu 404 that allows the user to check patent documents from around the world that provide a solution 402 for the patent document and at the same time have an objective 401 that is the same or similar to the patent document but has a different solution.

According to one embodiment of the present invention, a database in which objectives and solutions are extracted through an AI model for worldwide patent documents and then stored may be accessed to provide a download or output function for objectives and solutions for multiple patent documents. Alternatively, when a computing device 102 reviews a large number of patent documents for which a user has requested review, it may provide objectives and solutions extracted through an AI model in addition to the index of the patent documents, thereby enabling the user to more quickly and easily understand complex and lengthy technical contents written in the patent documents.

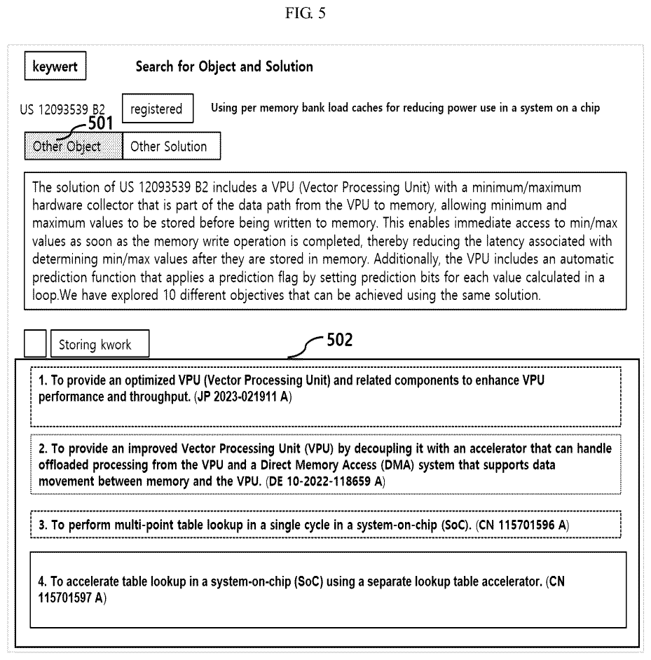

FIG. 5 is a diagram illustrating an example list of global patent documents having the same or similar solution and different objectives for a user-selected patent document according to an embodiment of the present invention.

FIG. 5 shows the result of selecting the menu 403 shown in FIG. 4. The menu 403 may correspond to the menu 501 when the user selects the US registered patent document U.S. Pat. No. 12,093,539B2. When the user selects the US registered patent document U.S. Pat. No. 12,093,539B2, computing device 102 may extract a plurality of patent documents having the same or similar solution as the US registered patent document U.S. Pat. No. 12,093,539B2 but different objectives from the U.S. Pat. No. 12,093,539B2 through a similarity comparison between the patent documents, and then extract a certain number of patent documents and provide them as a list 502. Computing device 102 may, at the user's request, display a menu that may store the patent documents selected from the list 502 or switch to an authoring tool or an editing tool for reviewing the patent documents.

In addition, computing device 102 may provide the patent document U.S. Pat. No. 12,093,563B2 requested by the user in a unified language Korean or English set in computing device 102 even if the patent document was applied in a different country and is used in a different language.

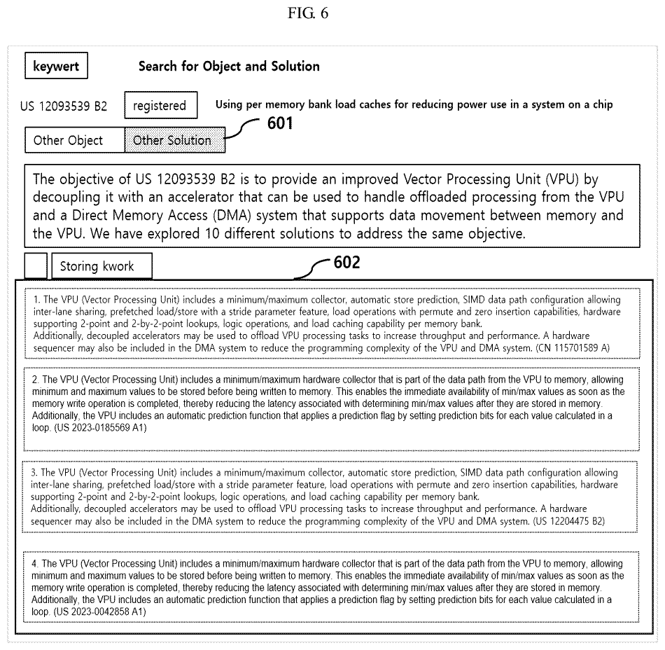

FIG. 6 is a diagram illustrating an example list of global patent documents having the same or similar objective and different solutions for a user-selected patent document according to an embodiment of the present invention.

FIG. 6 shows the result of selecting the menu 404 shown in FIG. 4. The menu 404 may correspond to the menu 601 when the user selects the US registered patent document U.S. Pat. No. 12,093,539B2. When the user selects the US registered patent document U.S. Pat. No. 12,093,539B2, computing device 102 may extract a plurality of patent documents having the same or similar objective as the US registered patent document U.S. Pat. No. 12,093,539B2 but having different solutions from the U.S. Pat. No. 12,093,539B2 through a similarity comparison between the patent documents, and may then extract a certain number of patent documents and provide them as a list 602. Computing device 102 may, at the user's request, display a menu that may store the patent documents selected from list 602 or switch to an authoring tool or an editing tool for reviewing the patent documents.

In addition, computing device 102 may provide the patent document U.S. Pat. No. 12,093,563B2 requested by the user in a unified language Korean or English set in computing device 102 even if the patent document was applied in a different country and is used in a different language.

The embodiments of the present invention may be implemented by, for example, hardware, firmware, software, or combinations thereof. In the case of implementation by hardware, according to hardware implementation, the exemplary embodiment described herein may be implemented by using one or more application specific integrated circuits ASICs, digital signal processors DSPs, digital signal processing devices DSPDs, programmable logic devices PLDs, field programmable gate arrays FPGAs, processors, controllers, micro-controllers, microprocessors, and the like.

Further, in the case of implementation by firmware or software, the embodiment of the present invention may be implemented in the form of a module, a procedure, a function, and the like to perform the functions or operations described above and recorded in recording media readable by various computer means. Herein, the recording medium may include singly a program instruction, a data file, or a data structure or a combination thereof. The program instruction recorded in the recording medium may be specially designed and configured for the present invention, or may be publicly known to and used by those skilled in the computer software field. Examples of the recording media include magnetic media such as a hard disk, a floppy disk, and a magnetic tape, optical media such as a CD-ROM Compact Disk Read Only Memory and a DVD Digital Video Disk, magneto-optical media such as a floptical disk, and a hardware device which is specifically configured to store and execute the program instruction such as a ROM, a RAM, and a flash memory. An example of the program instruction includes a high-level language code executable by a computer by using an interpreter and the like, as well as a machine language code created by a compiler. The hardware devices may be configured to operate as one or more software modules in order to perform the operation of the present invention, and an opposite situation thereof is available.

In addition, an apparatus or terminal according to the present invention may be driven by instructions that cause one or more processors to perform the functions and processes described above. The instructions may include, for example, interpreted instructions such as script instructions, such as JavaScript or ECMAScript instructions, executable codes or other instructions stored in computer readable media. Further, the device according to the present invention may be implemented in a distributed manner across a network, such as a server farm, or may be implemented in a single computer device.

In addition, a computer program also known as a program, software, software application, script or code that is embedded in the device according to the present invention and which implements the method according to the present invention may be prepared in any format of a compiled or interpreted language or a programming language including a priori or procedural language and may be deployed in any format including standalone programs or modules, components, subroutines, or other units suitable for use in a computer environment. The computer program does not particularly correspond to a file in a file system. The program may be stored in a single file provided to a requested program, in multiple interactive files e.g., a file storing one or more modules, subprograms, or portions of code, or in a part e.g., one or more scripts stored in a markup language document of a file storing another program or data. The computer program may be located on one site or distributed over a plurality of sites to be executed on multiple computers or one computer interconnected by a communication network.

Although the drawings have been described for the sake of convenience of explanation, it is also possible to design a new embodiment to be implemented by merging the embodiments described in each drawing. Further, configurations and methods of the described embodiments may not be limitedly applied to the aforementioned present invention, but all or some of the respective embodiments may be selectively combined and configured so as to be variously modified.

Further, while the embodiments of the present invention have been illustrated and described above, the present invention is not limited to the aforementioned specific embodiments, various modifications may be made by a person with ordinary skill in the technical field to which the present invention pertains without departing from the subject matters of the present invention that are claimed in the claims, and these modifications should not be appreciated individually from the technical spirit or prospect of the present invention.

The present invention may be applied to various patent document search engine technology fields and/or machine learning technology fields.

What is claimed is:

1. A method for extracting objectives and solutions from patent documents performed by a computing device, comprising:
extracting objectives and solutions from the technical content included in a first patent document;
receiving a viewing request for the first patent document;
displaying the objectives and solutions of the first patent document in response to the viewing request;
searching for at least one second patent document having the same or similar solution as the patent document and having different objectives, in response to a searching request for the objective form a user; and
providing at least one second patent documents.

2. The method of claim 1, wherein the objectives and solutions of the first patent document and the second patent document are provided in Korean or English as set in computing device.

3. The method of claim 1, wherein, even if applimayt country for the first patent document is same as the second patent documents, the character of the second patent document is translated according to the language setting of computing device.

4. The method of claim 1, further comprising:
switching to an editing tool or an authoring tool that allows the user to review the first patent document upon request; and
providing the objectives and solutions of the first patent document along with other information of the first patent document within the editing tool or authoring tool.

5. A method for extracting objectives and solutions from patent documents performed by a computing device, comprising:
extracting objectives and solutions from the technical content included in a first patent document;
receiving a viewing request for the first patent document;
displaying the objectives and solutions of the first patent document in response to the viewing request;
searching for at least one second patent document having the same or similar objective as the patent document and having different solutions, in response to a searching request for the solution form a user; and
providing at least one second patent documents.

6. The method of claim 5, wherein the objectives and solutions of the first patent document and the second patent document are provided in Korean or English as set in computing device.

7. The method of claim 5, wherein, even if applimayt country for the first patent document is same as the second patent documents, the character of the second patent document is translated according to the language setting of computing device.

8. The method of claim 5, further comprising:
switching to an editing tool or an authoring tool that allows the user to review the first patent document upon request; and
providing the objectives and solutions of the first patent document along with other information of the first patent document within the editing tool or authoring tool.

9. A computing device for performing a method of extracting objectives and solutions from patent documents, computing device comprising a processor,
wherein the processor is configured to:
extract objectives and solutions from the technical content included in a first patent document;
receive a viewing request for the first patent document;
display the objectives and solutions of the first patent document in response to the viewing request;
search for i at least one second patent document having the same or similar solution as the patent document and having different objectives, in response to a searching request for the objective, or ii at least one second patent document having the same or similar objective as the patent document and having different solutions, in response to a searching request for the solution,
provide at least one second patent documents.

10. Computing device of claim 9, wherein the objectives and solutions of the first patent document and the second patent document are provided in Korean or English as set in computing device.

11. The method of claim 9, wherein, even if applimayt country for the first patent document is same as the second patent documents, the character of the second patent document is translated according to the language setting of computing device.

12. Computing device of claim 9, wherein the processor configured to:
switch to an editing tool or an authoring tool that allows the user to review the first patent document upon request; and
provide the objectives and solutions of the first patent document along with other information of the first patent document within the editing tool or authoring tool.
